(19) United States
(12) Patent Application Publication
(10) Pub. No.: US 2010/0053142 A1
(43) Pub. Date: Mar. 4, 2010

(54) ELECTRO-OPTICAL DEVICE AND ELECTRONIC DEVICE

(75) Inventor: Kenya WATANABE, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/543,650

(22) Filed: Aug. 19, 2009

(30) Foreign Application Priority Data
Aug. 28, 2008 (JP) 2008-220406

(51) Int. Cl. G06F 3/038

(52) U.S. Cl. 345/211

(57) ABSTRACT

An electro-optical device includes: an active element layer in which a pixel circuit including a memory circuit for storing gradation data is formed; a pixel electrode formed to overlap with the active element layer, so that an electric potential in accordance with the gradation data is supplied thereto; an electro-optical layer driven in accordance with the electric potential of the pixel electrode; and first and second power supply lines for supplying power to the memory circuit, wherein the first and second power supply lines include portions interposed between the active element layer and the pixel electrode, so that the first and second power supply lines form a capacitor.

### BACKGROUND

1. Technical Field

The present invention relates to the structure of an electro-optical device using an electro-optical element such as a liquid crystal element, etc.

2. Related Art

There has been heretofore proposed an electro-optical device having a plurality of wiring layers and pixel electrodes laminated in an active element layer constituting an active element (for example, a liquid crystal device of JP-A-8-328034). The pixel electrode is formed so as to cover the active element layer or the wiring layer, thereby to apply a voltage to an electro-optical layer (for example, the liquid crystal of a liquid crystal device). Also, in JP-A-2005-189274, there is disclosed a pixel circuit including a memory circuit (latch circuit). The memory circuit stores gradation data for designating a gradation. The pixel circuit supplies an electric potential to a pixel electrode in accordance with the gradation data stored in the memory circuit.

In a configuration in which power is supplied to the memory circuit, as in the pixel circuit of JP-A-2005-189274, the electric potential of a power supply line can vary in an instant due to the flow of electric current at the time the gradation data is written to the memory circuits of a plurality of the pixel circuits, and therefore it is difficult to stably write and hold correct gradation data into the memory device. Also, in a configuration in which an active element layer, a wiring layer including a power supply line, and a pixel electrode are laminated, as in JP-A-8-328034, there is also a problem that variation in the electric potential of a power supply line affects the electric potential of the active element layer or the pixel electrode.

### SUMMARY

An advantage of some aspects of the invention is that it reduces the influence of variation in the electric potential of a power supply line of a memory circuit in a pixel circuit.

According to an aspect of the invention, there is provided an electro-optical device including: an active element layer in which a pixel circuit including a memory circuit for storing gradation data is formed; a pixel electrode formed to overlap with the active element layer, so that an electric potential in accordance with the gradation data is supplied thereto; an electro-optical layer (for example, a liquid crystal layer 146) driven in accordance with the electric potential of the pixel electrode; and first and second power supply lines for supplying power to the memory circuit, wherein the first and second power supply lines include portions interposed between the active element layer and the pixel electrode, so that the first and second power supply lines form a capacitor (for example, a capacitor C1 in FIGS. 2 or 10). In this configuration, since the first and second power supply lines for supplying power to the pixel circuit (specifically, the memory circuit) form a capacitor, variation in the electric potential in the first power supply line or the second power supply line is suppressed. Therefore, there is an advantage that trouble (for example, a malfunction of the pixel circuit or variation in the electric potential of the pixel electrode) due to variation in the electric potential of the first power supply line or the second power supply line is suppressed.

In the meantime, in a configuration in which signal lines for supplying gradation data to the pixel circuits are formed, there can arise a problem that a potential of a component adjacent to the signal line concerned varies in relation to variation in the electric potential of the signal line (a level of the gradation data). Therefore, in an electro-optical device including signal lines extending in a first direction, from the viewpoint of reduction of the influence of the electric potential of the signal line, a configuration in which the first power supply line is formed from the same layer as the signal line to extend in the first direction is suitable. In this aspect, since the first power supply line is formed from the same layer as the signal line to extend in the first direction, there is an advantage that the influence of variation in potential in the signal line on other electric conductors is reduced.

In particular, focusing on a configuration in which plural sets of pixel circuit and pixel electrode are arranged, a suitable configuration is one in which a plurality of signal lines extending in the first direction, and a plurality of first power supply lines formed from the same layer as the plurality of signal lines are put together such that each first power supply line extends in the first direction in each gap between the adjacent signal lines. According to this aspect, since the first power supply line functions as a shield between the signal lines, there is an advantage in that the influence of potential variation in the signal lines is reduced.

Further, the effect of reducing the influence of variation in electric potential of the signal line on other electric conductors is realized by extending the signal line and the first power supply line in parallel in the first direction. Therefore, from the sole viewpoint of reducing the influence of variation in the electric potential of the signal line on other electric conductors, the configuration of the invention in which the first power supply line and the second power supply line form a capacitor may be omitted.

In the electro-optical device in which a plurality of first power supply lines extend in the first direction, a configuration in which the plurality of first power supply lines conduct to an auxiliary wiring (for example, an auxiliary wiring 36 in FIG. 7) extending in the second direction intersecting with the first direction is suitable. In this aspect, there is an advantage that potential variation in each first power supply line is effectively suppressed. Further, in the electro-optical device including a plurality of second power supply lines, a configuration in which each second power supply line conducts to the common auxiliary wirings is suitable.

According to a first aspect (for example, a first embodiment) of the invention, the first power supply line and the second power supply line are formed from the same layer. In this aspect, there is an advantage that the forming process of the power supply lines is simplified as compared with a configuration in which the first and second power supply lines are formed from separate layers.

According to a specific example of the first aspect, the first power supply line includes a plurality of first projecting portions protruding toward the second power supply line, and the second power supply line includes a plurality of second projecting portions each located in each gap between the plurality of first projecting portions. Namely, each of the first and second power supply lines is formed into the shape of the teeth of a comb, and these teeth are arranged to intermesh with each other. In this aspect, since the area of the opposing side end surfaces of the first and second power supply lines increases as compared with, for example, a case where each of the first and second power supply lines is formed into a simple straight shape, it is possible to sufficiently secure the capacitance value of the capacitor formed by the first and second power supply lines.

According to a specific example of the first aspect, the pixel electrode is formed of a light reflective electric conductor so as to overlap with a gap region between the first power supply line and the second power supply line. In this aspect, since the gap region between the first power supply line and the second power supply line is light-shielded by the pixel electrode, there is an advantage that light irradiation to the active element layer is effectively prevented.

According to a second aspect of the invention, the first and second power supply lines are formed from separate layers so as to face each other with an insulating layer therebetween. In this aspect, the opposing area of the first and second power supply lines increases as compared with a configuration in which the first and second power supply lines are formed from the same layer. Therefore, it is possible to sufficiently secure the capacitance value of the capacitor formed by the first and second power supply lines.

According to a preferred aspect of the invention, the second power supply line includes a portion interposed between the signal line and the pixel electrode. In this aspect, since the second power supply line is interposed between the signal line and the pixel electrode, there is an advantage that the influence of variation in the electric potential of the signal line (variation in the level of the gradation data) on the pixel electrode is reduced.

Further, according to an aspect in which the first power supply line includes a portion interposed between the signal line and the active element layer, there is an advantage that the influence of variation in the electric potential of the signal line on the active element layer (the pixel electrode) is reduced.

According to a preferred aspect of the invention, the size or the position of the first and second power supply lines or the pixel electrode is chosen such that the capacitance value of the capacitor formed by the first and second power supply lines in the pixel circuit exceeds the capacitance formed by the first and second power supply lines and the pixel electrode. For example, in the electro-optical device according to the first aspect, in the case where the pixel circuit and the pixel electrode are electrically connected by an intermediate electric conductor (for example, an intermediate electric conductor 62 in FIG. 4) formed from the same layer as those of the first and second power supply lines, the distance between the first power supply line and the second power supply line is set smaller than the distance between each of the first and second power supply lines and the intermediate electric conductor. In this configuration, since the capacitance formed by the first and second power supply lines is sufficiently secured, the effect of suppressing variation in the electric potential of the first power supply line or the second power supply line is particularly remarkable.

The electro-optical device according to the invention can be utilized in a variety of electronic devices. A typical example of the electronic device is a device using the electro-optical device as a display device. As the electronic device according to the invention, a personal computer or a portable telephone is given as an example. First of all, application of the electro-optical device according to the invention is not limited to the display of an image. The electro-optical device according to the invention may be applied, for example, as an exposure device (exposure head) for forming a latent image on an image support such as a photoreceptor drum by irradiation of a ray of light.

### BRIEF DESCRIPTION OF THE DRAWINGS

The invention will be described with reference to the accompanying drawings, wherein like numbers reference like elements.

FIG. 1 is a block diagram of an electro-optical device according to a first embodiment of the invention.

FIG. 2 is a circuit diagram of a pixel circuit.

FIG. 3 is a cross-sectional view of the electro-optical device.

FIG. 4 is a plan view showing components on the face of a first substrate.

FIG. 5 is a cross-sectional view of an electro-optical device according to a second embodiment of the invention.

FIG. 6 is a plan view showing components on the face of a first substrate.

FIG. 7 is a plan view showing components on the face of a first substrate in an electro-optical device according to a third embodiment.

FIG. 8 is a cross-sectional view showing the relationship between a power supply line and a signal line in a modification example.

FIG. 9 is a cross-sectional view showing the relationship between a power supply line and a signal line in another modification example.

FIG. 10 is a circuit diagram of a pixel circuit according to a modification example.

FIG. 11 is a schematic diagram of an electronic device (projection type display device).

### DESCRIPTION OF EXEMPLARY EMBODIMENTS

### First Embodiment

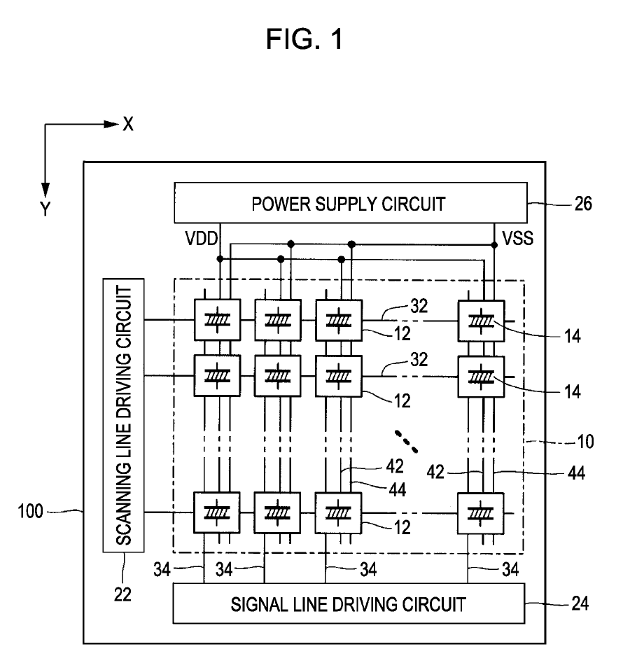

FIG. 1 is a block diagram of an electro-optical device according to a first embodiment of the invention. The electro-optical device 100 functions as a display device which is mounted on an electronic device so as to display an image. As shown in FIG. 1, the electro-optical device 100 includes an element portion (display region) 10 in which plural sets of pixel circuit 12 and liquid crystal element 14 are arranged; a scanning line driving circuit 22 and a signal line driving circuit 24, which drive each pixel circuit 12; and a power supply circuit 26 for generating electric potentials (VDD, VSS) used in the element portion 10.

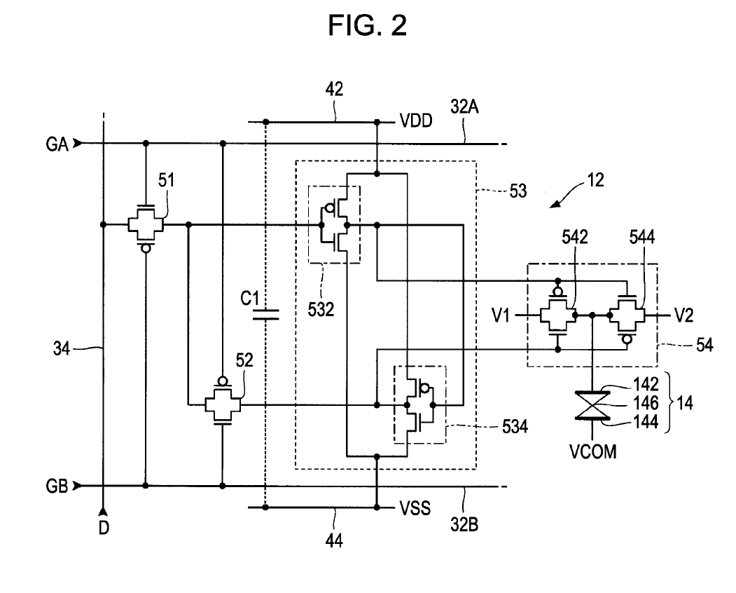

In the element portion 10, there are formed a plurality of scanning lines 32 extending in the X direction, and a plurality of signal lines 34 extending in the Y direction intersecting with the X direction. A plurality of pixel circuits 12 are each disposed at the intersection of each scanning line 32 and each signal line 34, so that they are arranged in a matrix shape. As shown in FIG. 2, the pixel circuit 12 is constituted of a complementary type MOS transistor, thereby driving the liquid crystal element 14. The liquid crystal element 14 is a capacitor with a liquid crystal 146 interposed between a pixel electrode 142 and a counter electrode 144 and is set so that the gradation (transmittivity) of the liquid crystal 146 is variable in accordance with the voltage between the pixel electrode 142 and the counter electrode 144.

As shown in FIG. 1, in the element portion 10, there are formed a plurality of power supply lines 42 and a plurality of power supply lines (ground lines) 44, which extend in the Y direction along with each signal line 34. The power supply circuit 26 generates a high level side potential VDD of an electric source, thereby supplying it to each power supply lines 42, and a low level side potential VSS of an electric source, thereby supplying it to each power supply lines 44.

The scanning line driving circuit 22 selects sequentially each of a plurality of scanning lines 32 in each subfield period division of one field period. As shown in FIG. 2, the scanning line 32 in FIG. 1 is comprised of scanning lines 32A and 32B. To the scanning line 32A, a scanning signal GA, which becomes high level when selected by the scanning line driving circuit 22, is supplied, and to the scanning line 32B, a scanning signal GB, which is generated by inverting a logic level of the scanning signal GA, is supplied.

The signal line driving circuit 24 in FIG. 1 outputs a gradation data D to each signal line 34 for every subfield period in synchronization with the selection of the scanning line 32 by the scanning line driving circuit 22. The gradation data D is a 1-bit digital data which designates whether the liquid crystal element 14 is on/off. The gradation of the liquid crystal element 14 is controlled to be variable in accordance with the sum of the time lengths of the subfield periods when the liquid crystal element 14 concerned is controlled to be in an ON state during one field period.

As shown in FIG. 2, the pixel circuit 12 includes a switch 51, a switch 52, a memory circuit 53, and a control circuit 54. Each of the switches 51 and 52 is a transfer gate made of a combination of N-channel and P-channel transistors. The switches 51 and 52 complementarily operate in accordance with the scanning signals GA and GB.

The memory circuit 53 is a circuit (latch circuit) for storing the gradation data D and has a configuration in which inverter circuits 532 and 534 are circularly connected. Each of the inverter circuits 532 and 534 is constituted of P-channel and N-channel transistors which are interposed between the power supply lines 42 and 44. The switch 51 is interposed between the signal line 34 and the input stage of the inverter circuit 532, and the switch 52 is interposed between the output stage of the inverter circuit 534 and the input stage of the inverter circuit 532.

In the configuration described above, when the scanning signal GA is set at a high level by a selection by the scanning line driving circuit 22, the switch 51 is changed into an ON state, whereby the gradation data D is input from the signal line 34 to the memory circuit 53. Then, when the scanning signal GB is changed into a high level, the switch 52 is changed into an ON state (a loop made of the inverter circuits 532 and 534 is formed), whereby the gradation data D which has been supplied from the signal line 34 just before is held at the memory circuit 53.

The control circuit 54 applies an electric potential (potential V1 or V2) in accordance with the gradation data D held at the memory circuit 53 to the pixel electrode 142 of the liquid crystal element 14. As shown in FIG. 2, the control circuit 54 is constituted of switches 542 and 544 which operate complementarily. Each of the switches 542 and 544 is a transfer gate made of a combination of N-channel and P-channel transistors. When the gradation data D supplied from the signal line 34 to the memory circuit 53 and held at the memory circuit is a high level, the switch 544 is changed into an ON state, whereby a potential V2 (for example, a potential for controlling the liquid crystal element 14 to become an ON state) is supplied to the pixel electrode 142. On the other hand, when the gradation data D is a low level, the switch 542 is changed into an ON state, whereby a potential V1 (for example, a potential for controlling the liquid crystal element 14 to become an OFF state) is supplied to the pixel electrode 142.

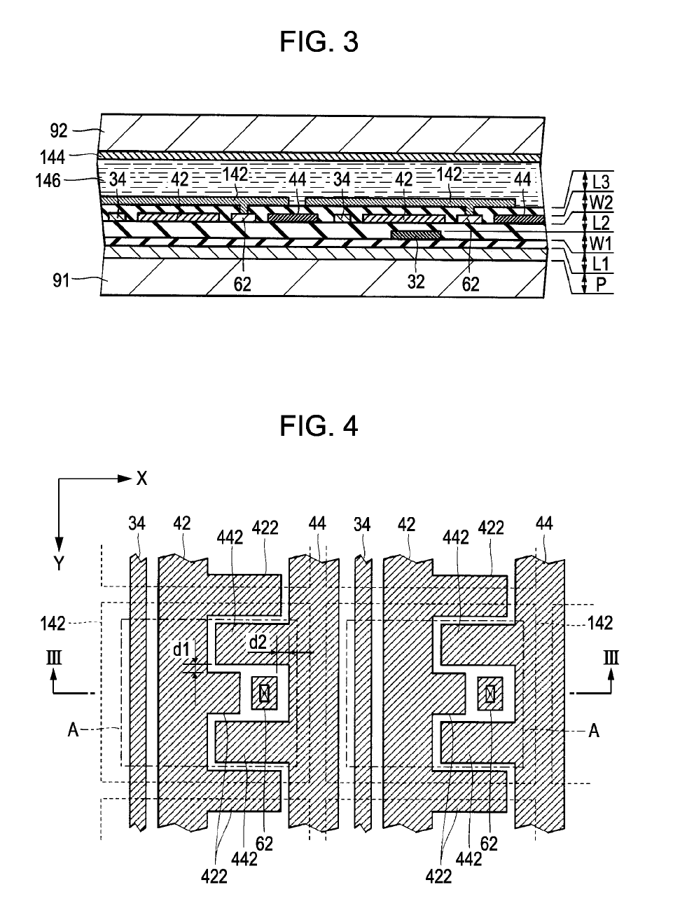

FIG. 3 is a cross-sectional view of the electro-optical device 100. As shown in FIG. 3, the electro-optical device 100 includes first and second substrates 91 and 92 which face each other with a distance therebetween. The liquid crystal 146 is sealed in a gap between the first and second substrates 91 and 92. FIG. 4 is a plan view showing components on the surface of the first substrate 91 facing the second substrate 92. A cross-sectional view taken along line III-III in FIG. 4 corresponds to FIG. 3.

As shown in FIGS. 3 and 4, on the surface of the first substrate 91 facing the second substrate 92, a plurality of pixel electrodes 142 are arranged in a matrix shape. In FIG. 4, the contours of the pixel electrodes 142 are shown by a broken line for convenience. Each pixel electrode 142 is a light reflective conductive film shaped in a rectangular shape. On the other hand, on the surface of the second substrate 92 facing the first substrate 91, as shown in FIG. 3, the light transmissive counter electrode 144 is formed over the entire surface. The liquid crystal element 14 is constituted by the liquid crystal 146 interposed between the respective pixel electrodes 142 on the first substrate 91 and the counter electrode 144 on the second substrate 92.

In the configuration described above, incident light from the second substrate 92 side (the viewing side) is transmitted through the second substrate 92 and the liquid crystal 146, then is reflected on the surface of the pixel electrode 142, and transmitted to the liquid crystal 146 and the second substrate 92, thereby advancing to the viewing side. That is, the electro-optical device 100 of this embodiment is a reflection type liquid crystal device. Further, in FIGS. 3 and 4, illustrations of an orientation film, a coloring layer, and a light shielding layer are omitted.

The first substrate 91 is a plate material formed of single crystalline silicon. As shown in FIG. 3, an active element layer P is formed on the surface of the first substrate 91 facing the second substrate 92. The active element layer P is a portion which constitutes a transistor of each component (each of the switch 51, the switch 52, the memory circuit 53, and the control circuit 54) of the pixel circuit 12, along with the first substrate 91. In FIG. 4, a region A in which the pixel circuit 12 is formed is shown by a dot-dashed line.

A wiring layer W1 is formed on the surface of an insulating layer L1 covering the active element layer P. The wiring layer W1 is formed of an electric conductor, for example, polysilicon and includes the scanning lines 32A and 32B. The scanning lines 32A and 32B are connected to the pixel circuit 12 (the active element layer P) via a conduction hole penetrating the insulating layer L1.

A wiring layer W2 is formed on the surface of an insulating layer L2 covering the wiring layer W1. The wiring layer W2 is formed of a light shielding (for example, light reflective) electric conductor and includes the power supply lines 42 and 44, the signal line 34, and an intermediate electric conductor 62. That is, the power supply lines 42 and 44, the signal line 34, and the intermediate electric conductor 62 are formed all at once in a common process by selectively removing a single conductive film (hereinafter referred to as “formed from the same layer”). Each component of the wiring layer W2 is connected to the pixel circuit 12 (the active element layer P) via a conduction hole formed in the insulating layer L2.

As shown in FIG. 4, a plurality of signal lines 34 extend in the Y direction in a juxtaposed state being spaced in the X direction. A plurality of power supply lines 42 and a plurality of power supply lines 44 extend in the Y direction along with the signal lines 34. More specifically, the power supply lines 42 and 44 corresponding to one row portion of the pixel circuits 12 are formed in a gap between the signal lines 34 adjacent to each other in the X direction and extend in the Y direction. The intermediate electric conductor 62 is an island shaped portion formed in a gap between the power supply line 42 and the power supply line 44. As shown in FIG. 4, most of a band-like region located in each gap between the signal lines 34 is covered by the power supply lines 42 and 44 and the intermediate electric conductor 62.

The power supply line 42 is formed into a shape (a form of the teeth of a comb) including a plurality of projecting portions 422 protruding in the X direction from its straight line shaped portion extending in the Y direction, toward the power supply line 44. Similarly, the power supply line 44 includes a plurality of projecting portions 442 protruding in the X direction from its straight line shaped portion extending in the Y direction, toward the power supply line 42. Each projecting portion 442 is located in each gap between the projecting portions 422. Namely, the power supply lines 42 and 44 are formed in such a manner that the plurality of projecting portions (the teeth of a comb) of both lines intermesh with each other. As described above, since the power supply lines 42 and 44 are close to each other, as shown in FIG. 2, the power supply lines 42 and 44 form (capacitive-couple) a capacitor C1.

As shown in FIG. 3, a plurality of pixel electrodes 142 are formed being spaced to each other on the surface of an insulating layer L3 covering the wiring layer W2. Each pixel electrode 142 is electrically connected to the intermediate electric conductor 62 via a conduction hole formed in the insulating layer L3. Namely, the pixel electrode 142 and the pixel circuit 12 (the active element layer P) are electrically connected to each other through the intermediate electric conductor 62. As in FIG. 4, when viewed from a direction perpendicular to the surface of the first substrate 91, the pixel electrode 142 entirely covers the region A in which the pixel circuit 12 is formed (that is, the entire periphery of the pixel circuit 12 is located outside of the region A). Therefore, as shown in FIG. 4, the pixel electrode 142 covers portions in the region A among gaps between the respective components of the wiring layer W2 (a gap between the power supply lines 42 and 44, a gap between the power supply line 42 or 44 and the intermediate electric conductor 62, and a gap between the power supply line 42 or 44 and the signal line 34).

The sizes or the positions of the power supply lines 42 and 44 or the pixel electrode 142, and the intermediate electric conductors 62 are chosen such that the capacitance value of the capacitor C1 formed in the pixel circuit 12 by the power supply lines 42 and 44 exceeds the capacitance formed by the power supply lines 42 and 44 and the pixel electrode 142 (the intermediate electric conductor 62). For example, as shown in FIG. 4, a distance (minimum value) d1 between the power supply line 42 and the power supply line 44 is less than a distance (minimum value) d2 between the power supply line 42 or 44 and the intermediate electric conductor 62.

As described with reference to FIG. 2, write-in of the gradation data D is carried out in parallel with respect to one row of a plurality of pixel circuits 12. Since at the time of write-in of the gradation data D, a through-current extending from the power supply line 42 to the power supply line 44 flows in the memory circuit 53 (the inverter circuits 532 and 534), there may be a case where an instantaneous variation in electric potential (a noise) occurs in the power supply line 42 or 44. In this embodiment, since the capacitor C1 is attached between the power supply lines 42 and 44 formed adjacent to each other, even in a case where a through-current has occurred in the memory circuit 53 at the time of the write-in of the gradation data D, potential variation in the power supply line 42 or 44 is suppressed (smoothed). Therefore, the problem that the gradation data D held at each pixel circuit 12 varies (is broken down) by the influence of noise of the power supply line 42 or 44 is solved. Namely, it is possible to stably write the gradation data D into the memory circuit 53 of each pixel circuit 12. Also, since the influence of potential variation in the power supply line 42 or 44 on the extent of the pixel electrode 142 or the active element layer P (each transistor of the pixel circuit 12) is reduced, there is also an advantage that malfunction of the pixel circuit 12 or the liquid crystal element 14 is prevented.

Further, in this embodiment, since the power supply lines 42 and 44 are formed such that each projecting portion 422 is located in each gap between the projecting portions 442, the area of the opposing side end surfaces of the power supply lines 42 and 44 (accordingly, the capacitor C1 between the power supply lines 42 and 44) is secured sufficiently as compared with a configuration in which the power supply lines 42 and 44 of a simple straight line shape are simply adjacent to each other. Therefore, the effect of suppressing variation in the electric potential of the power supply line 42 or 44 is particularly remarkable.

Also, when the incident light from the second substrate 92 side is transmitted to the liquid crystal 146, and then reaches the active element layer P, a photocurrent is generated in the transistor of the active element layer P, which causes a malfunction of the pixel circuit 12. In this embodiment, since the light shielding power supply line 42 or 44 (and the signal line 34 or the intermediate electric conductor 62) is formed to cover the region A in which the pixel circuit 12 is formed, light irradiation to the active element layer P (furthermore, a malfunction of the pixel circuit 12) is effectively prevented. Also, although each gap between the components of the wiring layer W2 can become a path of the incident light from the second substrate 92 side, in the region A of the pixel circuit 12, each gap region between the components of the wiring layer W2 is covered by the pixel electrode 142. Therefore there is an advantage that light irradiation to the active element layer P can be effectively blocked (and furthermore, that malfunction of the pixel circuit 12 can be effectively prevented).

Further, the power supply lines 42 and 44 are formed in each gap between adjacent signal lines 34. In other words, the space between the signal lines 34 is shielded by the power supply lines 42 and 44. Therefore, the influence of potential variation (change in gradation data D) in one of the adjacent two signal lines 34 on the potential of the other is suppressed as compared with a configuration in which an electric conductor does not exist in each gap between the signal lines 34. Therefore, also from the above viewpoint, the effect of stably writing the gradation data D into the memory circuit 53 of each pixel circuit 12 is effectively realized. Further, since the power supply lines 42 and 44 and the signal line 34 are formed from the same layer, there is also an advantage that the manufacturing process of the electro-optical device 100 is simplified as compared with a configuration in which each of the lines is formed of a separate layer.

### Second Embodiment

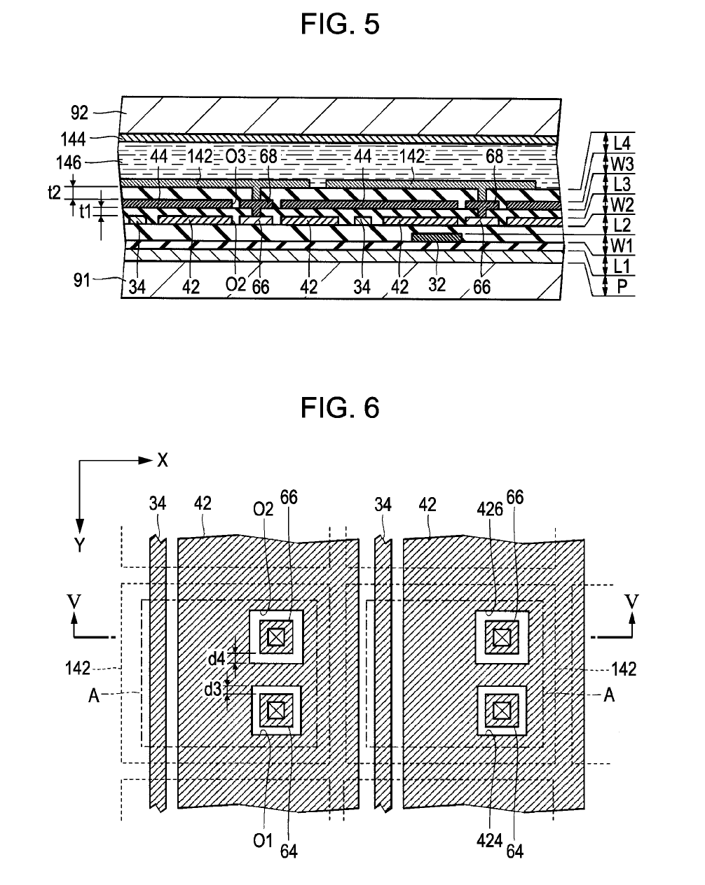

Next, the second embodiment of the invention is described. Also, in each embodiment below, the components having an operation or a function equivalent to those of the first embodiment are denoted by the same reference numerals, and the detailed description thereof will be omitted as appropriate. FIG. 5 is a cross-sectional view of the electro-optical device 100, and FIG. 6 is a plan view showing components on the surface of the first substrate 91 facing the second substrate 92. A cross-sectional view taken along line V-V in FIG. 6 corresponds to FIG. 5.

As shown in FIG. 5, on the surface of the insulating layer L2 covering the wiring layer W1, the wiring layer W2 is formed of a light shielding electric conductor. As shown in FIGS. 5 and 6, the wiring layer W2 includes the signal line 34 and the power supply line 42, which are formed for every row of the pixel circuits 12, and intermediate electric conductors 64 and 66 formed for every pixel circuit 12.

Each power supply line 42 is formed into a band shape to extend in the Y direction in a gap between the adjacent signal lines 34. As shown in FIG. 6, openings O1 and O2 are formed in the power supply line 42 within the region A of each pixel circuit 12. The intermediate electric conductor 64 is formed inside the opening O1, and the intermediate electric conductor 66 is formed inside the opening O2. Each of the intermediate electric conductors 64 and 66 conducts to the pixel circuit 12 (the active element layer P) through a conduction hole penetrating the insulating layers L2 and L1.

As shown in FIG. 5, on the surface of the insulating layer L3 covering the wiring layer W2, a wiring layer W3 is formed. Also, in FIG. 6, illustration of the wiring layer W3 is omitted. The wiring layer W3 is formed of a light shielding electric conductor and includes the power supply lines 44 and intermediate electric conductors 68. Namely, in the first embodiment, the power supply lines 42 and 44 are formed from the same layer, whereas in this embodiment, the power supply lines 42 and 44 are formed from separate layers.

The power supply line 44 is a conductive film continuing over a plurality of pixel circuits 12 (preferably, all pixel circuits 12) in the element portion 10. As shown in FIG. 5, the power supply line 42 and the power supply line 44 face each other with the insulating layer L3 therebetween. Therefore, the power supply line 42 and the power supply line 44 form (capacitive-couple) the capacitor C1 in FIG. 2 with the insulating layer L3 as a dielectric.

The power supply line 44 conducts to the intermediate electric conductor 64 (FIG. 6) in the wiring layer W2 through a conduction hole formed in the insulating layers L3. Therefore, the power supply line 44 is electrically connected to the pixel circuit 12 (the active element layer P) through the intermediate electric conductor 64. Also, as shown in FIG. 5, in the power supply line 44, opening O3 is formed so as to overlap with the opening O2 in the power supply line 42. The intermediate electric conductor 68 is formed inside the opening O3. As shown in FIGS. 5 and 6, the intermediate electric conductor 68 conducts to the intermediate electric conductor 66 through a conduction hole formed in the insulating layers L3.

On the surface of the insulating layer L4 covering the wiring layer W3, a plurality of pixel electrodes 142 are formed. As shown in FIG. 5, the pixel electrode 142 conducts to the intermediate electric conductor 68 through a conduction hole formed in the insulating layers L4. Namely, the pixel electrode 142 conducts to the pixel circuit 12 (the active element layer P) through the intermediate electric conductor 68 in the wiring layer W3 and the intermediate electric conductor 66 in the wiring layer W2. As shown in FIG. 5, the power supply line 44 is interposed between each pixel electrode 142 and the signal line 34. Therefore, it is possible to reduce the influence of potential variation in the signal line 34 on an electric potential of the pixel electrode 142 (namely, to allow the power supply line 44 to function as a shield).

The size or the position of the power supply lines 42 and 44, the pixel electrode 142, or each intermediate electric conductor 64, 66, or 68 is chosen such that the capacitance value of the capacitor C1 formed in the pixel circuit 12 by the power supply lines 42 and 44 exceeds the capacitance formed by the power supply line 42 or 44 and the pixel electrode 142 (the intermediate electric conductor 68). For example, as shown in FIG. 6, a distance d3 between the power supply line 42 and the intermediate electric conductor 64 is less than a distance d4 between the power supply line 42 and the intermediate electric conductor 66 or a distance d4 between the power supply line 44 and the intermediate electric conductor 68. Further, as shown in FIG. 5, a distance t1 between the power supply line 42 and the power supply line 44 is less than a distance t2 between the power supply line 44 and the pixel electrode 142.

Also in this embodiment, the same effects as those in the first embodiment are realized. For example, since the capacitor C1 is formed between the power supply line 42 and the power supply line 44, similarly to the first embodiment, the gradation data D is stably written and held in the memory circuit 53, and potential variation in the pixel electrode 142 and the active element layer P linked with the electric potential of the power supply line 42 or 44 is suppressed. Further, since the power supply line 42 is formed in each gap between the signal lines 34, the influence of variation in the electric potential of each signal line 34 on the other signal line 34 is reduced. Further, since the light shielding power supply line 44 covers the active element layer P, light irradiation to the active element layer P (furthermore, malfunction of the pixel circuit 12) is effectively prevented. In this embodiment, in particular, the power supply line 44 continues over the entire surface of the substrate, and therefore the effect of reducing light irradiation to the active element layer P is particularly remarkable as compared with the first embodiment.

### Third Embodiment

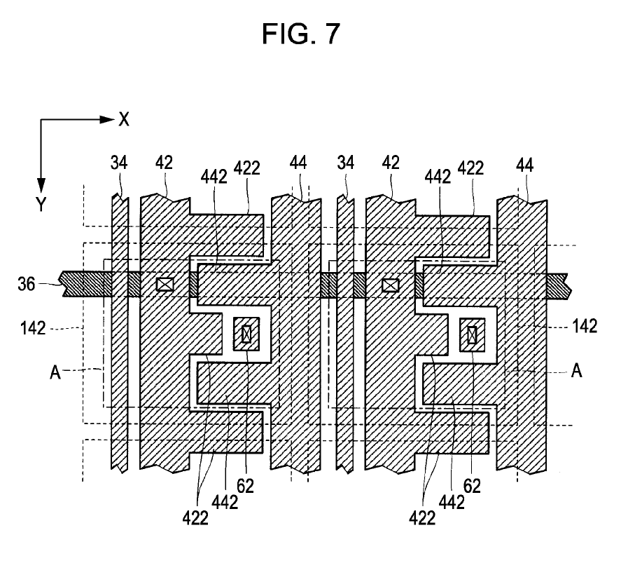

FIG. 7 is a plan view of the electro-optical device 100 according to a third embodiment of the invention (a plan view corresponding to FIG. 4). The electro-optical device 100 of this embodiment has a configuration in which a plurality of auxiliary wirings 36 formed for every row of the pixel circuits 12 are added to the configuration of the first embodiment. As shown in FIG. 7, each auxiliary wiring 36 is formed from the same layer as, for example, the scanning line 32 (the scanning lines 32A and 32B) and extends in the X direction. Namely, when viewed from a direction perpendicular to the surface of the first substrate 91, each auxiliary wiring 36 intersects with the power supply lines 42 and 44 extending in the Y direction. Each power supply line 42 is electrically connected to the auxiliary wiring 36 through a conduction hole penetrating the insulating layer L2. Namely, a plurality of power supply lines 42 conduct to each other through the auxiliary wiring 36.

In this embodiment, a plurality of power supply lines 42 conduct to each other through the auxiliary wiring 36 in the element portion 10, and therefore, as compared with a configuration in which each power supply line 42 does not conduct, there is an advantage that potential variation in each power supply line 42 is suppressed. Also, although in FIG. 7, there is illustrated a configuration in which each power supply line 42 conducts to the auxiliary wiring 36, instead of, or along with this configuration, a configuration in which a plurality of power supply lines 44 conduct to the auxiliary wiring 36 is also adopted. Also, a configuration in which a plurality of power supply lines 42 in the second embodiment conduct to the auxiliary wiring 36 is also suitable.

### MODIFICATION EXAMPLES

Each embodiment described above may be modified in various ways. Specific aspects of modifications to each embodiment will be illustrated below. Two or more aspects may be arbitrarily selected from the below illustrations to be combined.

### Modification Example 1

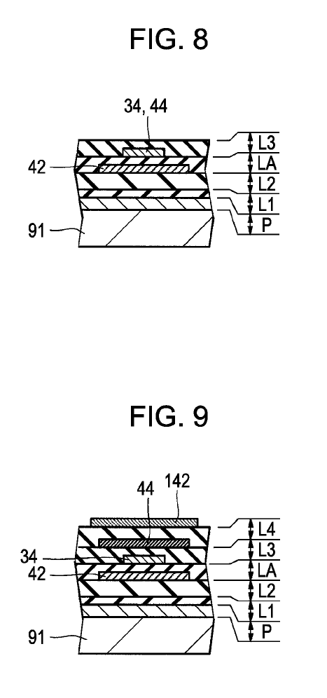

Although in each embodiment described above, the signal line 34 and the power supply line 42 are formed from the same layer, a configuration in which the signal line 34 and the power supply line 42 are formed from separate layers is also suitable. For example, as shown in FIG. 8, a configuration in which the power supply line 42 is formed on the surface of the insulating layer L2 and the signal line 34 is formed on the surface of an insulating layer LA covering the power supply line 42 is also suitable. In the configuration of FIG. 8, the power supply line 42 is interposed between each signal line 34 and the pixel circuit 12 (the active element layer P), and therefore it is possible to prevent the influence of potential variation in the signal line 34 on the electric potential of the active element layer P (for example, a malfunction of the pixel circuit 12). Also, as shown in FIG. 9, if a configuration of FIG. 8 in which the power supply line 42 is interposed between the signal line 34 and the active element layer P, and a configuration of the second embodiment (FIG. 6) in which the power supply line 44 is interposed between the signal line 34 and the pixel electrode 142 are combined, there is an advantage that the influence of variation in the electric potential of the signal line 34 on both the pixel electrode 142 and the active element layer P is reduced.

### Modification Example 2

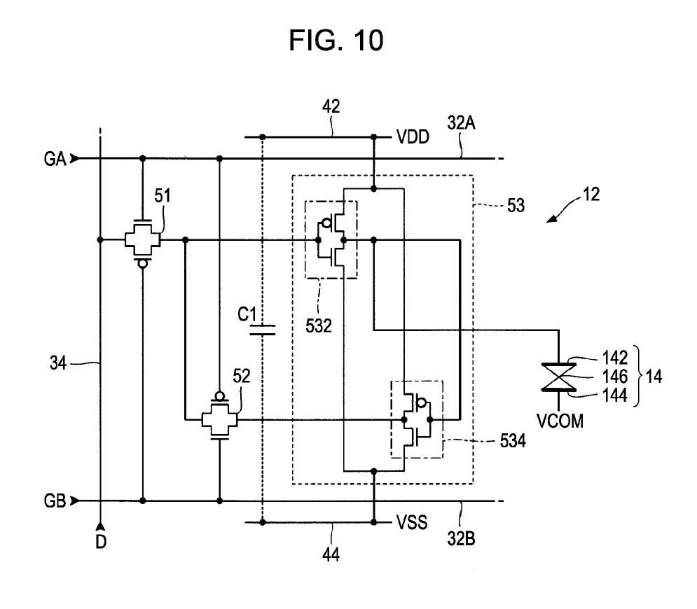

The configuration of the pixel circuit 12 may be suitably modified. For example, the pixel circuit 12 in FIG. 10 has a configuration in which the control circuit 54 of the pixel circuit 12 in FIG. 2 is omitted. Namely, the pixel electrode 142 of the liquid crystal element 14 is connected to the output stage of the inverter circuit 532 in the memory circuit 53. First of all, in each embodiment described above, variations in the electric potentials of the power supply lines 42 and 44 are suppressed, and therefore the invention is particularly suitable for the electro-optical device 100 in which there are arranged the pixel circuits 12 including a circuit (typically, the memory circuit 53 in FIG. 2 or 10) which receives a supply of power from the power supply lines 42 and 44, thereby operating.

### Modification Example 3

The levels of electric potentials supplied to the power supply lines 42 and 44 may be changed. For example, a configuration in which a low level side potential VSS is supplied to the power supply line 42, while a high level side potential VDD is supplied to the power supply line 44 is also suitable.

### Modification Example 4

The electro-optical layer in the invention is limited to the liquid crystal 146. For example, the invention is also applied to an electrophoresis device using a plurality of microcapsules (electrophoresis elements) in which black particles charged positively or negatively and white particles charged negatively or positively are sealed along with a dispersion medium, as an electro-optical layer. The pixel circuit 12 in FIG. 2 or 10 is used in the driving of the microcapsule. An element having an optical characteristic (gradation or brightness) varying in accordance with the electric potential of the pixel electrode 142, such as the liquid crystal element 14 or the microcapsule (the electrophoresis element), may be suitably used as an electro-optical layer in the invention.

### Application Example

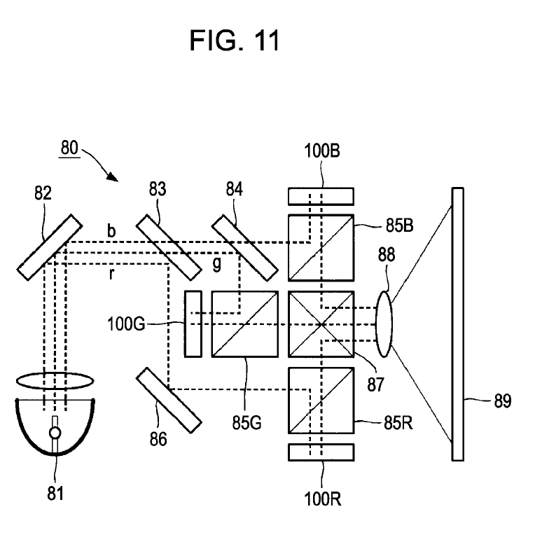

Next, an electronic device is described utilizing the electro-optical device 100 according to each embodiment described above. FIG. 11 is a schematic diagram illustrating a configuration of a projection type display device (projector) utilizing the electro-optical device 100. As shown in FIG. 11, the projection type display device 80 includes three electro-optical devices 100; 100R, 100G, 100B. The electro-optical device 100R is used in the modulation of red light r, the electro-optical device 100G is used in the modulation of green light g, and the electro-optical device 100B is used in the modulation of blue light b.

The emitted light (white light) from a light source 81, which has been reflected on a mirror 82, is separated into red light r, green light g, and blue light b by dichroic mirrors 83 and 84. The red light r is reflected on a mirror 86, and then enters the electro-optical device 100R through a polarization beam splitter 85R. The green light g enters the electro-optical device 100G through a polarization beam splitter 85G, and the blue light b enters the electro-optical device 100B through a polarization beam splitter 85B. The light emitted from each electro-optical device 100; 100R, 100G, 100B (the light reflected on the pixel electrode 142) are synthesized by a dichroic prism 87, and then projected on a screen 89 through a projection lens 88. Accordingly, a color image is displayed on the screen 89.

Also, as the electronic device to which the electro-optical device according to the invention is applied, other than the projection type display device illustrated in FIG. 11, a personal computer, a portable telephone, a portable information terminal (PDA: Personal Digital Assistants), a digital still camera, a television, a video camera, a car navigation apparatus, a pager, an electronic notebook, an electronic paper, a calculator, a word processor, a work station, a video telephone, a POS terminal, a printer, a scanner, a copier, a video player, an equipment incorporating a touch panel, and the like can be given.

The entire disclosure of Japanese Patent Application No: 2008-220406, filed Aug. 28, 2008 is expressly incorporated by reference herein.

What is claimed is:

1. An electro-optical device comprising:
an active element layer in which a pixel circuit including a memory circuit for storing gradation data is formed;
a pixel electrode formed to overlap with the active element layer, so that an electric potential in accordance with the gradation data is supplied thereto;
an electro-optical layer driven in accordance with the electric potential of the pixel electrode; and
first and second power supply lines for supplying power to the memory circuit,
wherein the first and second power supply lines include portions interposed between the active element layer and the pixel electrode, so that the first and second power supply lines form a capacitor.

2. The electro-optical device according to claim 1, further comprising a signal line extending in a first direction and supplying the gradation data to the pixel circuit,
wherein the first power supply line is formed from the same layer as that of the signal line and extends in the first direction.

3. The electro-optical device according to claim 1, comprising:
plural sets of the pixel circuit and the pixel electrode;
a plurality of signal lines extending in a first direction and supplying the gradation data to each pixel circuit; and
a plurality of the first power supply lines formed from the same layer as that of the signal lines such that each first power supply line extends in the first direction in a gap between adjacent signal lines.

4. The electro-optical device according to claim 3, further comprising an auxiliary wiring extending in a second direction intersecting with the first direction,
wherein the plurality of first power supply lines conduct to the auxiliary wiring.

5. The electro-optical device according to claim 1, wherein the first and second power supply lines are formed from the same layer.

6. The electro-optical device according to claim 5, wherein the first power supply line includes a plurality of first projecting portions protruding toward the second power supply line, and
the second power supply line includes a plurality of second projecting portions each located in each gap between the plurality of first projecting portions.

7. The electro-optical device according to claim 5, wherein the pixel electrode is formed of a light reflective electric conductor so as to overlap with a gap region between the first power supply line and the second power supply line.

8. The electro-optical device according to claim 5, further comprising an intermediate electric conductor formed from the same layer as those of the first and second power supply lines and electrically connecting the pixel circuit and the pixel electrode,
wherein the distance between the first power supply line and the second power supply line is smaller than the distance between each of the first and second power supply lines and the intermediate electric conductor.

9. The electro-optical device according to claim 1, wherein the first and second power supply lines are formed from separate layers so as to face each other with an insulating layer therebetween.

10. The electro-optical device according to claim 2, wherein the second power supply line includes a portion interposed between the signal line and the pixel electrode.

11. The electro-optical device according to claim 2, wherein the first power supply line includes a portion interposed between the signal line and the active element layer.

12. An electronic device provided with the electro-optical device according to claim 1.
